(19) United States
(12) Patent Application Publication
(10) Pub. No.: US 2022/0404553 A1
(43) Pub. Date: Dec. 22, 2022

(54) OPTICAL COMMUNICATION BETWEEN INTEGRATED CIRCUIT DEVICE ASSEMBLIES

(71) Applicant: Intel Corporation, Santa Clara, CA (US)

(72) Inventors: Ankur Agrawal, Chandler, AZ (US); Benjamin Duong, Phoenix, AZ (US); Ravindranath Mahajan, Chandler, AZ (US); Debendra Mallik, Chandler, AZ (US); Srinivas Pietambaram, Chandler, AZ (US)

(73) Assignee: Intel Corporation, Santa Clara, CA (US)

(21) Appl. No.: 17/354,446

(22) Filed: Jun. 22, 2021

(51) Int. Cl. G02B 6/26

(52) U.S. Cl. CPC G02B 6/26

(57) ABSTRACT

An integrated circuit package may be formed comprising a first integrated circuit assembly, a second integrated circuit assembly, and a means to transfer optical signals therebetween. This optical signal transfer may be facilitated with a first lens or a first micro-lens array adjacent at least one waveguide of the first integrated circuit assembly and a second lens or second micro-lens array adjacent at least one waveguide of the second integrated circuit assembly, wherein the optical signals are transmitted across a gap between the first lens/micro-lens array and the second lens/micro-lens array. In further embodiments, the optical signal transfer assembly may comprise at least one photonic bridge between at least one waveguide of the first integrated circuit assembly and at least one waveguide of the second integrated circuit assembly.

### TECHNICAL FIELD

Embodiments of the present description generally relate to the field of integrated circuit assemblies and, more particularly, to the assemblies and method of optical signal transfer between stacks of integrated circuit devices in integrated circuit packages.

### BACKGROUND

The integrated circuit industry is continually striving to produce ever faster and smaller integrated circuit devices for use in various server and mobile electronic products, including but not limited to, computer server products and portable products, such as wearable integrated circuit systems, portable computers, electronic tablets, cellular phones, digital cameras, and the like.

As these goals are achieved, the integrated circuit devices become smaller. However, communication demands have been increasing considerably faster than scaling (e.g., Moore's law) can achieve. For example, machine intelligence systems are requiring core counts in the thousands, “near compute” memory of greater than 10 gigabytes, connectivity bandwidth of greater than one terabyte per second between multiple nodes, low latency, thermal control, and good manufacturability, as will be understood to those skilled in the art. Of course, signal loss significantly increases with metal conductive routes (used for electrical interconnects) as signaling frequency increases and distance between the integrated circuit devices increases. Furthermore, the routing of the conductive routes becomes increasingly complex as more integrated circuit devices are added to an integrated circuit package.

These issues are exacerbated with regard to integrated circuit stacks (e.g., multiple integrated circuit devices stacked upon and in electrically communication with one another). As will be understood to those skilled in the art, it may be difficult to communicate between an upper integrated circuit device in a first integrated circuit stack and an upper integrated circuit device in a second integrated circuit stack without significant signal loss, due to the complexity and distance of the conductive routes.

Advances have been made with regard to signaling with the use of silicon-based electrical bridges and optical bridge embedded in electronic substrates to which the integrated circuit devices and stacks are attached. However, communication demands are outstripping these advances. Thus, the communication between integrated circuit devices continues to be a significant challenge.

### BRIEF DESCRIPTION OF THE DRAWINGS

The subject matter of the present disclosure is particularly pointed out and distinctly claimed in the concluding portion of the specification. The foregoing and other features of the present disclosure will become more fully apparent from the following description and appended claims, taken in conjunction with the accompanying drawings. It is understood that the accompanying drawings depict only several embodiments in accordance with the present disclosure and are, therefore, not to be considered limiting of its scope. The disclosure will be described with additional specificity and detail through use of the accompanying drawings, such that the advantages of the present disclosure can be more readily ascertained, in which:

FIGS. 1-8 are oblique and side-cross sectional views of a process of fabricating an integrated circuit package, according to an embodiment of the present description.

FIG. 9 is an oblique view of an integrated circuit package having horizontal and vertical optical communication, according to another embodiment of the present description.

FIGS. 10 and 11 are oblique and side-cross sectional views, respectively, of an integrated circuit assembly, according to one embodiment of the present description.

FIGS. 12 and 13 are oblique and side-cross sectional views, respectively, of an integrated circuit assembly, according to one embodiment of the present description.

FIG. 14 is an oblique view of an integrated circuit package, according to one embodiment of the present description.

FIGS. 15-20 are side-cross sectional views of a process of fabricating an integrated circuit package, according to an embodiment of the present description.

FIGS. 21-23 are side-cross sectional views of a process of fabricating the integrated circuit package, according to another embodiment of the present description.

FIG. 24 is an electronic system, according to one embodiment of the present description.

### DETAILED DESCRIPTION

In the following detailed description, reference is made to the accompanying drawings that show, by way of illustration, specific embodiments in which the claimed subject matter may be practiced. These embodiments are described in sufficient detail to enable those skilled in the art to practice the subject matter. It is to be understood that the various embodiments, although different, are not necessarily mutually exclusive. For example, a particular feature, structure, or characteristic described herein, in connection with one embodiment, may be implemented within other embodiments without departing from the spirit and scope of the claimed subject matter. References within this specification to “one embodiment” or “an embodiment” mean that a particular feature, structure, or characteristic described in connection with the embodiment is included in at least one implementation encompassed within the present description. Therefore, the use of the phrase “one embodiment” or “in an embodiment” does not necessarily refer to the same embodiment. In addition, it is to be understood that the location or arrangement of individual elements within each disclosed embodiment may be modified without departing from the spirit and scope of the claimed subject matter. The following detailed description is, therefore, not to be taken in a limiting sense, and the scope of the subject matter is defined only by the appended claims, appropriately interpreted, along with the full range of equivalents to which the appended claims are entitled. In the drawings, like numerals refer to the same or similar elements or functionality throughout the several views, and that elements depicted therein are not necessarily to scale with one another, rather individual elements may be enlarged or reduced in order to more easily comprehend the elements in the context of the present description.

The terms “over”, “to”, “between” and “on” as used herein may refer to a relative position of one layer with respect to other layers. One layer “over” or “on” another layer or bonded “to” another layer may be directly in contact with the other layer or may have one or more intervening layers. One layer “between” layers may be directly in contact with the layers or may have one or more intervening layers.

The term “package” generally refers to a self-contained carrier of one or more dice, where the dice are attached to the package substrate, and may be encapsulated for protection, with integrated or wire-bonded interconnects between the dice and leads, pins or bumps located on the external portions of the package substrate. The package may contain a single die, or multiple dice, providing a specific function. The package is usually mounted on a printed circuit board for interconnection with other packaged integrated circuits and discrete components, forming a larger circuit.

Here, the term “cored” generally refers to a substrate of an integrated circuit package built upon a board, card or wafer comprising a non-flexible stiff material. Typically, a small printed circuit board is used as a core, upon which integrated circuit device and discrete passive components may be soldered. Typically, the core has vias extending from one side to the other, allowing circuitry on one side of the core to be coupled directly to circuitry on the opposite side of the core. The core may also serve as a platform for building up layers of conductors and dielectric materials.

Here, the term “coreless” generally refers to a substrate of an integrated circuit package having no core. The lack of a core allows for higher-density package architectures, as the through-vias have relatively large dimensions and pitch compared to high-density interconnects.

Here, the term “land side”, if used herein, generally refers to the side of the substrate of the integrated circuit package closest to the plane of attachment to a printed circuit board, motherboard, or other package. This is in contrast to the term “die side”, which is the side of the substrate of the integrated circuit package to which the die or dice are attached.

Here, the term “dielectric” generally refers to any number of non-electrically conductive materials that make up the structure of a package substrate. For purposes of this disclosure, dielectric material may be incorporated into an integrated circuit package as layers of laminate film or as a resin molded over integrated circuit dice mounted on the substrate.

Here, the term “metallization” generally refers to metal layers formed over and through the dielectric material of the package substrate. The metal layers are generally patterned to form metal structures such as traces and bond pads. The metallization of a package substrate may be confined to a single layer or in multiple layers separated by layers of dielectric.

Here, the term “bond pad” generally refers to metallization structures that terminate integrated traces and vias in integrated circuit packages and dies. The term “solder pad” may be occasionally substituted for “bond pad” and carries the same meaning.

Here, the term “solder bump” generally refers to a solder layer formed on a bond pad. The solder layer typically has a round shape, hence the term “solder bump”.

Here, the term “substrate” generally refers to a planar platform comprising dielectric and metallization structures. The substrate mechanically supports and electrically couples one or more IC dies on a single platform, with encapsulation of the one or more IC dies by a moldable dielectric material. The substrate generally comprises solder bumps as bonding interconnects on both sides. One side of the substrate, generally referred to as the “die side”, comprises solder bumps for chip or die bonding. The opposite side of the substrate, generally referred to as the “land side”, comprises solder bumps for bonding the package to a printed circuit board.

Here, the term “assembly” generally refers to a grouping of parts into a single functional unit. The parts may be separate and are mechanically assembled into a functional unit, where the parts may be removable. In another instance, the parts may be permanently bonded together. In some instances, the parts are integrated together.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, magnetic or fluidic connection between the things that are connected or an indirect connection, through one or more passive or active intermediary devices.

The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The vertical orientation is in the z-direction and it is understood that recitations of “top”, “bottom”, “above” and “below” refer to relative positions in the z-dimension with the usual meaning. However, it is understood that embodiments are not necessarily limited to the orientations or configurations illustrated in the figure.

The terms “substantially,” “close,” “approximately,” “near,” and “about,” generally refer to being within +/−10% of a target value (unless specifically specified). Unless otherwise specified the use of the ordinal adjectives “first,” “second,” and “third,” etc., to describe a common object, merely indicate that different instances of like objects to which are being referred and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

Views labeled “cross-sectional”, “profile” and “plan” correspond to orthogonal planes within a cartesian coordinate system. Thus, cross-sectional and profile views are taken in the x-z plane, and plan views are taken in the x-y plane. Typically, profile views in the x-z plane are cross-sectional views. Where appropriate, drawings are labeled with axes to indicate the orientation of the figure.

Embodiments of the present description relate to optical signal transfer between side surfaces of a first integrated circuit assembly and a second integrated circuit assembly of an integrated circuit package with an optical transfer assembly positioned therebetween. In various embodiments, the optical signal transfer assembly may comprise a first lens or a first micro-lens array adjacent at least one waveguide of the first integrated circuit assembly and a second lens or second micro-lens array adjacent at least one waveguide of the second integrated circuit assembly, wherein the optical signals are transmitted across a gap between the first lens/lens structure and the second lens/lens structure. In further embodiments, the optical signal transfer assembly may comprise at least one photonic bridge between at least one waveguide of the first integrated circuit assembly and at least one waveguide of the second integrated circuit assembly.

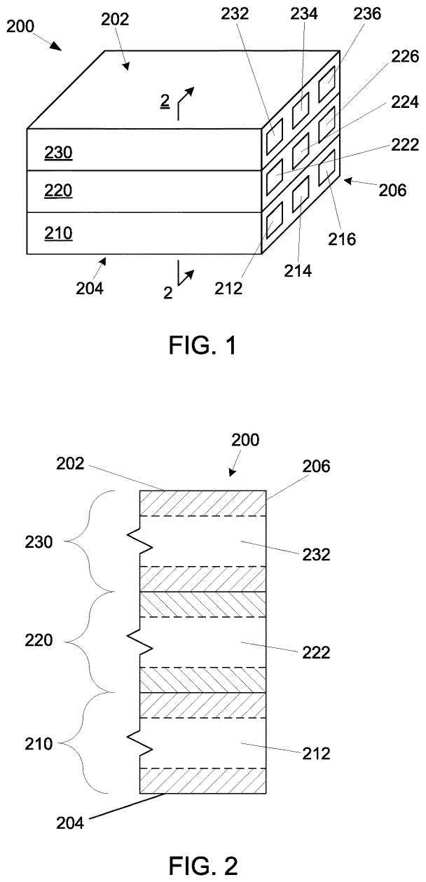

FIGS. 1-8 are oblique and side-cross sectional views of a process of fabricating an integrated circuit package 100 (see FIG. 8), according to an embodiment of the present description. As shown in FIGS. 1 and 2 (cross sectional view along line 2-2 of FIG. 1), a first integrated circuit assembly 200 may be fabricated, wherein the first integrated circuit assembly 200 may comprise a first surface 202, an opposing second surface 204, and at least one side surface 206 extending between the first surface 202 and the second surface 204. In one embodiment of the present description, the first integrated circuit assembly 200 may comprise a plurality of integrated circuit devices (illustrated as a first integrated circuit device 210, a second integrated circuit device 220 on and electrically attached to the first integrated circuit device 210, and a third integrated circuit device 230 on and electrically attached to the second integrated circuit device 220). The fabrication and electrical attachment of integrated circuit devices are well known in the art, and, for the purposes of clarity and conciseness, will not be described herein.

The first integrated circuit assembly 200 may include at least one waveguide, which is a part of a photonic integrated circuit. As shown in FIGS. 1 and 2, in one embodiment of the present description, at least one of the illustrated integrated circuit devices 210, 220, and 230, may include at least one waveguide. In the illustrated embodiment of FIG. 1, the first integrated circuit device 210 may include a first waveguide 212, a second waveguide 214, and a third waveguide 216. The second integrated circuit device 220 may include a first waveguide 222, a second waveguide 224, and a third waveguide 226. The third integrated circuit device 230 may include a first waveguide 232, a second waveguide 234, and a third waveguide 236. These waveguides 212-216, 222-226, and 232-236 may extend to the at least one side surface 206 of the first integrated circuit assembly 200. Although the first integrated circuit assembly 200 is illustrated as a stack of integrated circuit devices 210, 220, and 230, it is understood that the first integrated circuit assembly 200 may be a single integrated circuit device or have more integrated circuit devices than the three illustrated. Any of the first integrated circuit device 210, the second integrated circuit device 220, and the third integrated circuit device 230 may be entirely a photonic circuit device, may be an integrated circuit (such as a microprocessor, a chipset, a graphics device, a wireless device, a memory device, an application specific integrated circuit, a transceiver device, an input/output device, combinations thereof, or the like) that includes a photonic integrated circuit component, or may be a system on a chip (SOC) that includes a photonic integrated circuit component. It is understood that the first integrated circuit assembly 200 and/or the second integrated circuit assembly 400 may include integrated circuit devices that do not have photonic components.

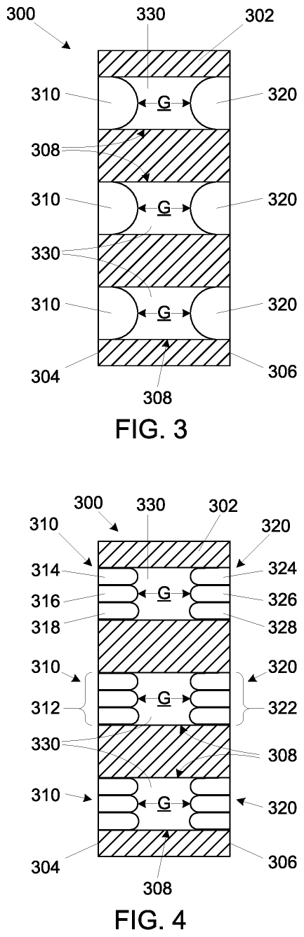

As shown in FIG. 3, in one embodiment of the present description, an optical signal transfer assembly 300 may be formed comprising an array structure 302 having a first side 304 and an opposing second side 306, with at least one photon transmission conduit 308 extending through the array structure 302 from the first side 304 to the second side 306 thereof. The optical signal transfer assembly 300 may further include at least one first lens 310 positioned within a corresponding photon transmission conduit 308 at the first side 304 of the array structure 302 and at least one second lens 320 positioned within each photon transmission conduit 308 at the second side 306 of the array structure 302. The first lenses 310 may be spaced with a gap G from corresponding second lenses 320 within each photon transmission conduit 308. In one embodiment, space 330, if any, within each photon transmission conduit 308 may be filled with an optically transmissive material. Furthermore, the material used to form the array structure 302 may act as a cladding material, as will be understood to those skilled in the art. Although FIG. 3, illustrates the first lenses 310 and the second lenses 320 as single structure, the embodiments of the present description are not so limited. In another embodiment of the present description, as shown in FIG. 4, the first lenses 310 may be first micro-lens arrays 312 consisting of a plurality of micro-lenses 314, 316, and 318, and the second lenses 320 may be second micro-lens arrays 322 consisting of a plurality of micro-lenses 324, 326, and 328. The operation of lens in the direction and focus of light is well known in the art, and, as such, for the purposes of clarity and conciseness, will not be discussed herein.

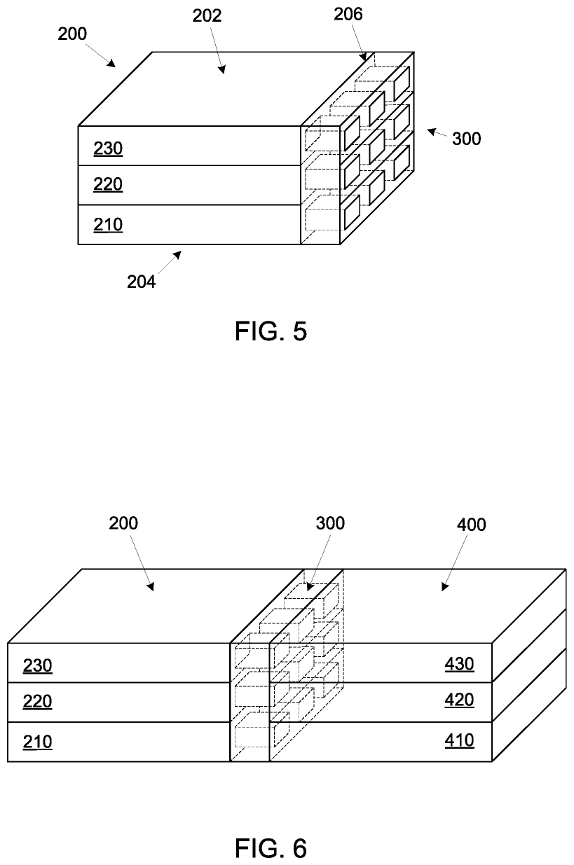

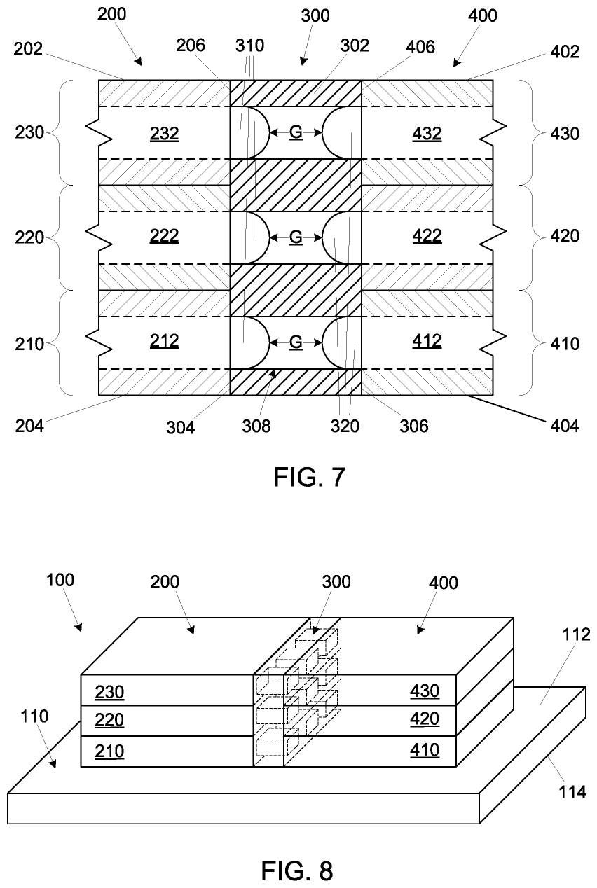

As shown in FIG. 5, the optical signal transfer assembly 300 may be abutted or attached to the at least one side surface 206 of the first integrated circuit assembly 200. As shown in FIGS. 6 and 7, a second integrated circuit assembly 400 may be abutted or attached to the at least one second side 306 of the optical signal transfer assembly 300. The second integrated circuit assembly 400 may be similar to the first integrated circuit assembly 200. In one embodiment of the present description, the second integrated circuit assembly 400 may comprise a first surface 402, an opposing second surface 404, and at least one side surface 406 extending between the first surface 402 and the second surface 404. In one embodiment of the present description, the second integrated circuit assembly 400 may comprise a plurality of integrated circuit devices (illustrated as a first integrated circuit device 410, a second integrated circuit device 420 on and electrically attached to the first integrated circuit device 410, and a third integrated circuit device 430 on and electrically attached to the second integrated circuit device 420).

The second integrated circuit assembly 400 may include at least one waveguide, which is a part of a photonic integrated circuit. As shown in FIGS. 6 and 7, in one embodiment of the present description, at least one of the illustrated integrated circuit devices 410, 420, and 430, may include at least one waveguide. In an embodiment of the present description, the first integrated circuit device 410, the second integrated circuit deice 420, and the third integrated circuit device 430 may have waveguides (not shown in FIG. 6) that are positioned to be the mirror image of the waveguides of the first integrated circuit assembly 200.

As shown in FIG. 7, the at least one side surface 206 of the first integrated circuit assembly 200 may abut the first side 304 of the optical signal transfer assembly 300, and the at least one side surface 406 of the second integrated circuit assembly 400 may abut the second side 306 of the optical signal transfer assembly 300, such that the waveguides of the first integrated circuit assembly 200 align with the first lenses 310 of the optical signal transfer assembly 300 and such that the waveguides of the second integrated circuit assembly 400 align with the second lenses 320 of the optical signal transfer assembly 300. Thus, for example, as illustrated in FIG. 7, the optical signal transfer assembly 300 optically couples the first waveguide 212 of the first integrated circuit device 210 of the first integrated circuit assembly 200 with a first waveguide 412 of the first integrated circuit device 410 of the second integrated circuit assembly 400, optically couples the first waveguide 222 of the second integrated circuit device 220 of the first integrated circuit assembly 200 with a first waveguide 422 of the second integrated circuit device 420 of the second integrated circuit assembly 400, and optically couples the first waveguide 232 of the third integrated circuit device 230 of the first integrated circuit assembly 200 with a first waveguide 432 of the third integrated circuit device 430 of the second integrated circuit assembly 400.

As shown in FIG. 8, the structure of FIG. 6 may be electrically attached to a package substrate 110, such as by hybrid bonding, solder connection, or the like, as known in the art, to form the integrated circuit package 100. The package substrate 110 may be any appropriate structure, including, but not limited to, an interposer. The package substrate 110 may have a first surface 112 and an opposing second surface 114. The package substrate 110 may comprise a plurality of dielectric material layers (not shown), which may include build-up films and/or solder resist layers, and may be composed of an appropriate dielectric material, including, but not limited to, bismaleimide triazine resin, fire retardant grade 4 material, polyimide material, silica filled epoxy material, glass reinforced epoxy material, low temperature co-fired ceramic materials, and the like, as well as low-k and ultra low-k dielectrics (dielectric constants less than about 3.6), including, but not limited to, carbon doped dielectrics, fluorine doped dielectrics, porous dielectrics, organic polymeric dielectrics, fluoropolymers, and the like.

The package substrate 110 may further include conductive routes or “metallization” extending through the package substrate 110. These conductive routes may be a combination of conductive traces (not shown) formed between the dielectric material layers (not shown) and conductive vias (not shown) extending through the dielectric material layers (not shown). The structure and fabrication of conductive traces and conductive vias are well known in the art and are not shown or described for purposes of clarity and conciseness. The conductive traces and the conductive vias may be made of any appropriate electrically conductive material, including, but not limited to, metals, such as copper, silver, nickel, gold, and aluminum, alloys thereof, and the like. As will be understood to those skilled in the art, the package substrate 110 may be a cored substrate (having core layers, such as silicon or glass interposers) or a coreless substrate.

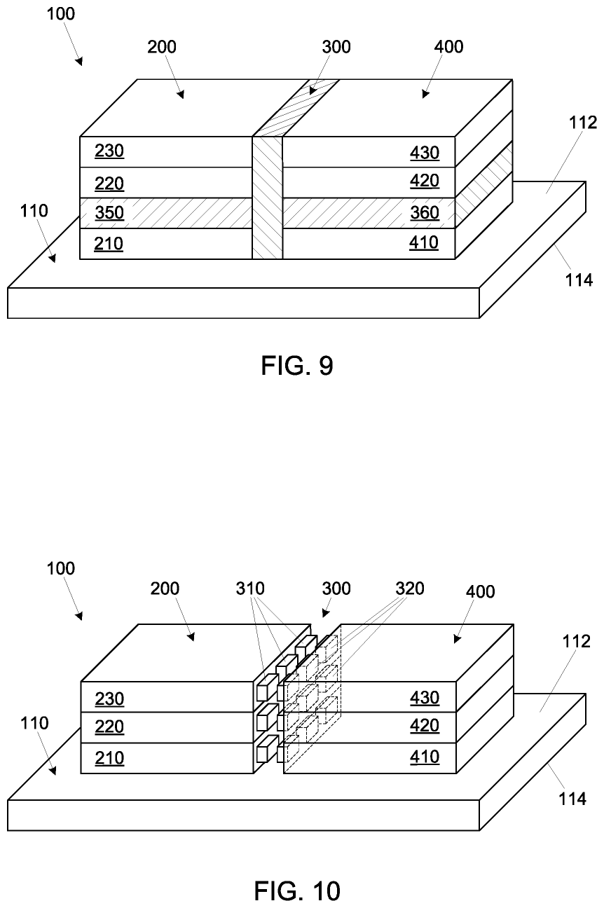

Although the embodiment shown in FIGS. 1-8 illustrates structures for the transfer of photonic signals between two integrated circuit assemblies, i.e., the first integrated circuit assembly 200 and the second integrated circuit assembly 400, the embodiments of the present description in not so limited. As shown in FIG. 9, additional optical signal transfer assemblies, shown as a first interlevel optical signal transfer assembly 350 and a second first interlevel optical signal transfer assembly 360 and, may be position within the first integrated circuit assembly 200 and the second integrated circuit assembly 400, respectively. In one embodiment, as shown in FIG. 9, the first interlevel optical signal transfer assembly 350 maybe be positioned between the first integrated circuit device 210 of the first integrated circuit assembly 200 and the second integrated circuit device 220 of the first integrated circuit assembly 200 for photonic signal transfer therebetween, and the second interlevel optical signal transfer assembly 360 may be positioned between the first integrated circuit device 410 of the second integrated circuit assembly 400 and the second integrated circuit device 420 of the second integrated circuit assembly 400 for photonic signal transfer therebetween. The first interlevel optical signal transfer assembly 350 and the second interlevel optical transfer assembly 360 in FIG. 9 may be formed in a similar manner as that of the optical transfer assembly 300 of FIGS. 1-8.

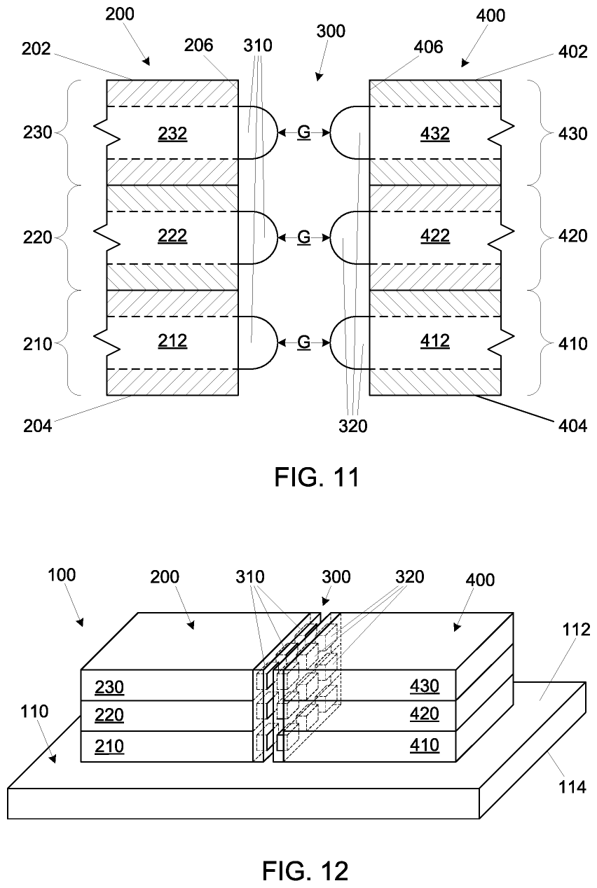

In a further embodiment of the present description, as shown in FIGS. 10 and 11, the first integrated circuit assembly 200 and the second integrated circuit assembly 400 may be electrically attached to the package substrate 110, such as by hybrid bonding, solder connection, or the like, as known in the art, and the array structure 302 may be eliminated, wherein the first lenses 310 may be attached to each waveguide of the first integrated circuit assembly 200 and the second lenses 320 may be attached to each waveguide of the second integrated circuit assembly 400. In one example shown in FIG. 11, the first lenses 310 of the optical signal transfer assembly 300 may be attached to the first waveguide 212 of the first integrated circuit device 210 of the first integrated circuit assembly 200, the first waveguide 222 of the second integrated circuit device 220 of the first integrated circuit assembly 200, and the first waveguide 232 of the third integrated circuit device 230 of the first integrated circuit assembly 200. The second lenses 320 of the optical signal transfer assembly 300 may be attached to the first waveguide 412 of the first integrated circuit device 410 of the second integrated circuit assembly 400, the first waveguide 422 of the second integrated circuit device 420 of the second integrated circuit assembly 400, and the first waveguide 432 of the third integrated circuit device 430 of the second integrated circuit assembly 400. The first lenses 310 and the second lenses 320 may be aligned such that the first waveguide 212 of the first integrated circuit device 210 of the first integrated circuit assembly 200 is in photonic communication with the first waveguide 412 of the first integrated circuit device 410 of the second integrated circuit assembly 400, such that the first waveguide 222 of the second integrated circuit device 220 of the first integrated circuit assembly 200 is in photonic communication with the first waveguide 422 of the second integrated circuit device 420 of the second integrated circuit assembly 400, and such that the first waveguide 232 of the third integrated circuit device 230 of the first integrated circuit assembly 200 is in photonic communication with the first waveguide 432 of the third integrated circuit device 430 of the second integrated circuit assembly 400. As shown in FIG. 11, photonic signals are transmitted across the gap G between the first lenses 310 and the second lenses 320. This gap G may extend through ambient air (e.g., free space), a cooling fluid, or the like.

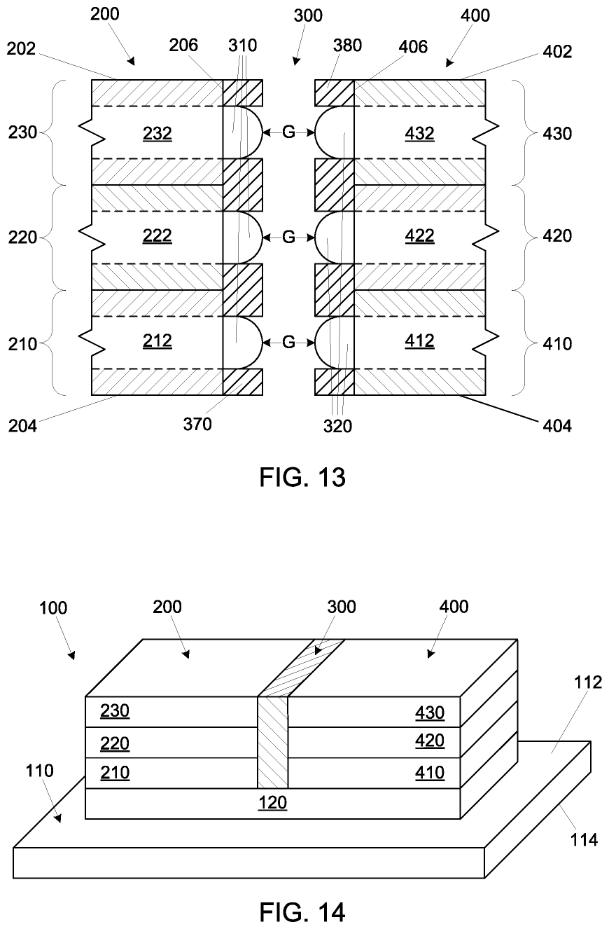

In still a further embodiment of the present description, as shown in FIGS. 12 and 13, the first integrated circuit assembly 200 and the second integrated circuit assembly 400 may be electrically attached to the package substrate 110, and the optical signal transfer assembly 300 may comprise the first lenses 310 within a first array structure 370 adjacent the at least one side surface 206 of the first integrated circuit assembly 200, and the second lenses 320 within a second array structure 380 adjacent the at least one side surface 406 of the second integrated circuit assembly 400. In one example shown in FIG. 13, the first lenses 310 of the optical signal transfer assembly 300 may be attached to the first waveguide 212 of the first integrated circuit device 210 of the first integrated circuit assembly 200, the first waveguide 222 of the second integrated circuit device 220 of the first integrated circuit assembly 200, and the first waveguide 232 of the third integrated circuit device 230 of the first integrated circuit assembly 200. The second lenses 320 of the optical signal transfer assembly 300 may be attached to the first waveguide 412 of the first integrated circuit device 410 of the second integrated circuit assembly 400, the first waveguide 422 of the second integrated circuit device 420 of the second integrated circuit assembly 400, and the first waveguide 432 of the third integrated circuit device 430 of the second integrated circuit assembly 400. The first lenses 310 and the second lenses 320 may be aligned such that the first waveguide 212 of the first integrated circuit device 210 of the first integrated circuit assembly 200 is in photonic communication with the first waveguide 412 of the first integrated circuit device 410 of the second integrated circuit assembly 400, such that the first waveguide 222 of the second integrated circuit device 220 of the first integrated circuit assembly 200 is in photonic communication with the first waveguide 422 of the second integrated circuit device 420 of the second integrated circuit assembly 400, and such that the first waveguide 232 of the third integrated circuit device 230 of the first integrated circuit assembly 200 is in photonic communication with the first waveguide 432 of the third integrated circuit device 430 of the second integrated circuit assembly 400. As shown in FIG. 13, photonic signals are transmitted across the gap G between the first lenses 310 and the second lenses 320. This gap G may extend through ambient air (e.g., free space), a cooling fluid, or the like.

Although the embodiments of the present description illustrate the first integrated circuit assembly 200 and the second integrated circuit assembly 400 electrically attached to the package substrate 110 (see FIGS. 8 and 12), it is understood that the first integrated circuit assembly 200 and the second integrated circuit assembly 400 may be electrically attached to a base die 120, such as by hybrid bonding, solder connection, or the like, as known in the art, wherein the base die 120 is electrically attached to the package substrate 100, as shown in FIG. 14.

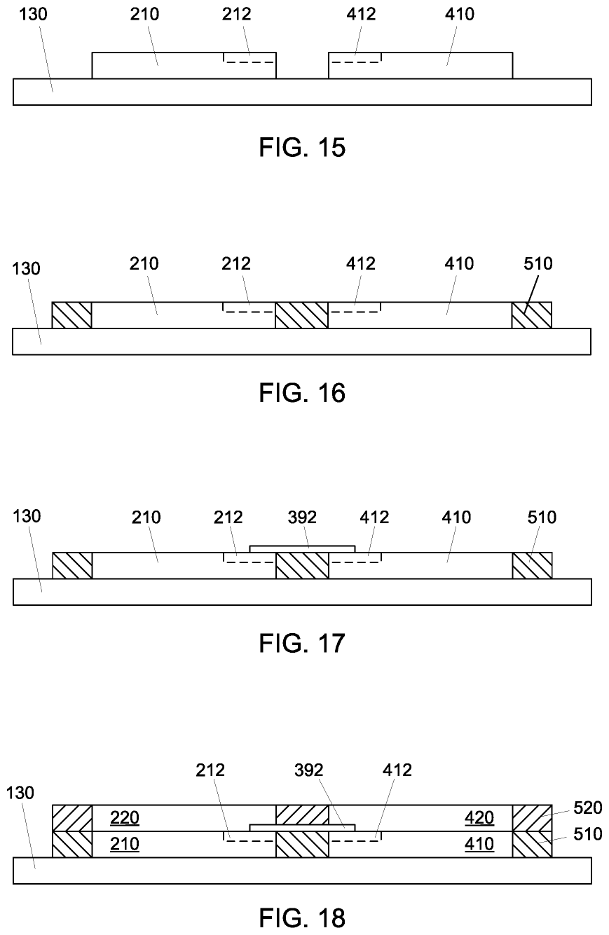

FIGS. 15-20 illustrate another embodiment of the present description, wherein an integrated circuit package may be fabricated using photonic bridges. As shown in FIG. 15, the first integrated circuit device 210 of the first integrated circuit assembly (e.g., element 200 of FIG. 6) and a first integrated circuit device 410 of the second integrated circuit assembly (e.g., element 400 of FIG. 6) may be secured to a first carrier 130. As shown in FIG. 16, a first mold material 510 may be formed to surround the first integrated circuit devices 210, 410, such as by deposition and planarization, as known in the art. As shown in FIG. 17, a first photonic bridge 392 may be attached to the first waveguide 212 of the first integrated circuit device 210 of the first integrated circuit assembly (e.g., element 200 of FIG. 6) and the first waveguide 412 of the first integrated circuit device 410 of the second integrated circuit assembly (e.g., element 400 of FIG. 6) to facilitate the transmission of photonic signals therebetween. The first photonic bridge 392 may be attached by any known technique, including, but not limited to, a die-to-wafer hybrid bonding process. The first photonic bridge 392 may be any appropriate optical transmission structure, such a waveguide only or a waveguide with active components. Furthermore, it understood that the first photonic bridge 392 may also include electrical routing/connections (not shown) between the first integrated circuit device 210 of the first integrated circuit assembly and the second integrated circuit device 410 of the second integrated circuit assembly. Moreover, it understood that the first photonic bridge 392 may also include electrical routing/connections (not shown) between the first integrated circuit device 210 of the first integrated circuit assembly and the second integrated circuit device 220 of the first integrated circuit assembly. It is still further understood that optical couplers (not shown) such as via grating couplers, evanescent couplers, mirrors, lenses, and the like, may be positioned between first waveguide 212 of the first integrated circuit device 210 of the first integrated circuit assembly 200 and the first photonic bridge 392, and positioned between first waveguide 412 of the first integrated circuit device 410 of the second integrated circuit assembly 400 and the first photonic bridge 392.

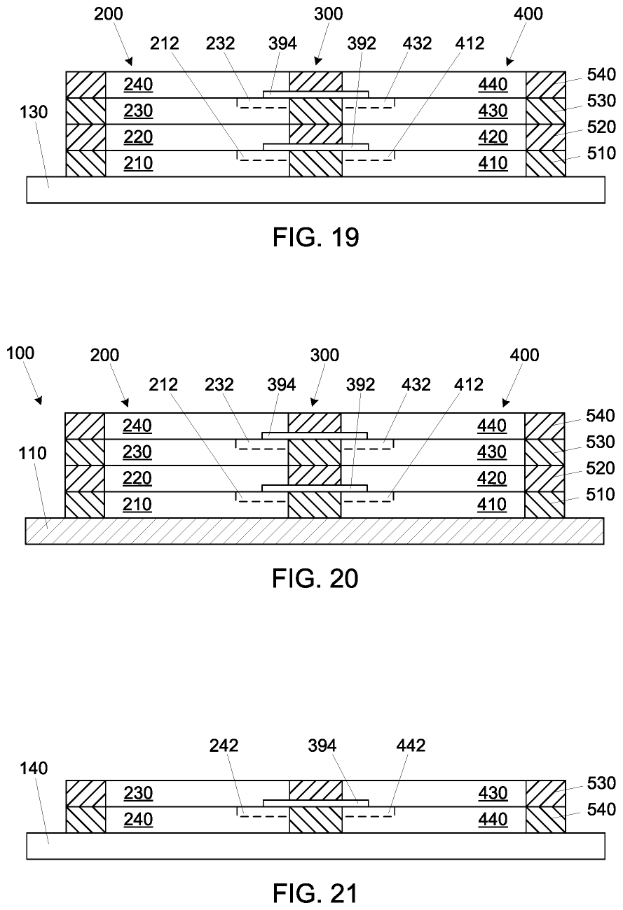

As shown in FIG. 18, the second integrated circuit device 220 may be electrically attached by any known method, such as a die-to-wafer bonding process to the first integrated circuit device 210, and the second integrated circuit device 420 may be electrically attached by any known method, such as a die-to-wafer bonding process, to the first integrated circuit device 410. A second mold material 520 may be formed to surround the second integrated circuit devices 220, 420, such as by deposition and planarization, as known in the art. The process of FIGS. 15-18 may be repeated to form the first integrated circuit assembly 200 comprising the first integrated circuit device 210, the second integrated circuit device 220, the third integrated circuit device 230, and a fourth integrated circuit device 240, to form the second integrated circuit assembly 400 comprising the first integrated circuit device 410, the second integrated circuit device 420, the third integrated circuit device 430, and a fourth integrated circuit device 440, and to form the optical signal transfer assembly 300 comprising the first photonic bridge 392 and a second photonic bridge 394, as shown in FIG. 19. The second photonic bridge 394 may be attached to the first waveguide 232 of the third integrated circuit device 230 and the first waveguide 432 of the third integrated circuit device 430 to facilitate the transmission of photonic signals therebetween. It is noted that the structure of FIG. 19 may also include a third mold material 530 surrounding the third integrated circuit devices 230, 430, and a fourth mold material 540 surrounding the fourth integrated circuit devices 240, 440. As shown in FIG. 20, the structure of FIG. 19 may be removed from the first carrier 130 (see FIG. 19) and electrically attached to the package substrate 110 to form the integrated circuit package 100. It is understood that the package substrate 110 is sufficiently rigid, such as by having total thickness variation/warpage control (i.e., glass core or silicon interposer), then the structure FIG. 20 may be formed direction on the package substrate 110 without the need of the first carrier 120.

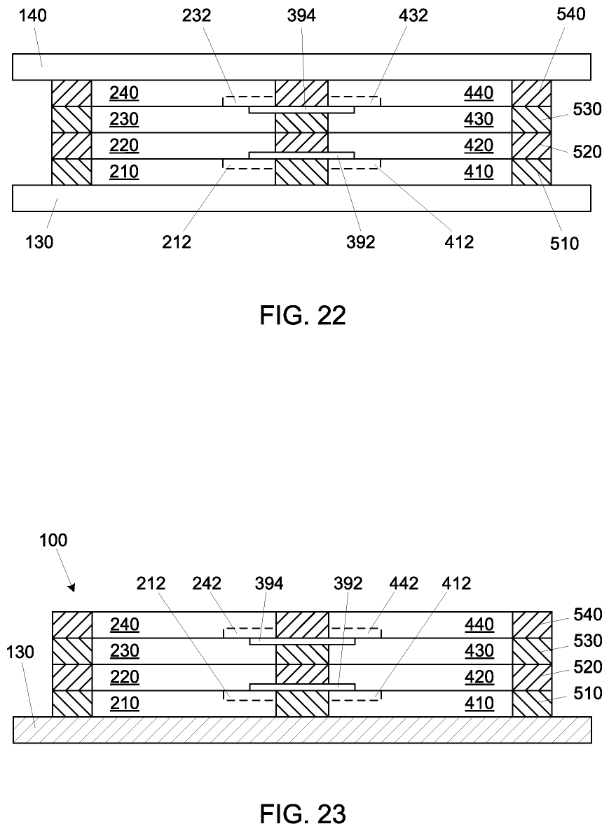

FIGS. 21-23 illustrate another embodiment of the present description, the third integrated circuit devices 230, 430 and the fourth integrated circuit devices 240, 440 may be assembled on a second carrier 140 in the manner discussed with regard to FIG. 15-18, wherein the second photonic bridge 394 is attached to at first waveguide 242 of the fourth integrated circuit device 240 and a first waveguide 442 of the fourth integrated circuit device 440 to facilitate the transmission of photonic signals therebetween. As shown in FIG. 22, the assembly of FIG. 21 may be flipped and attached to the assembly of FIG. 18. As shown FIG. 23, the first carrier 130 (see. FIG. 22) and the second carrier 140 may be removed, and the first integrated circuit devices 210, 410 may be electrically attached to the package substrate 110 to form the integrated circuit package 100.

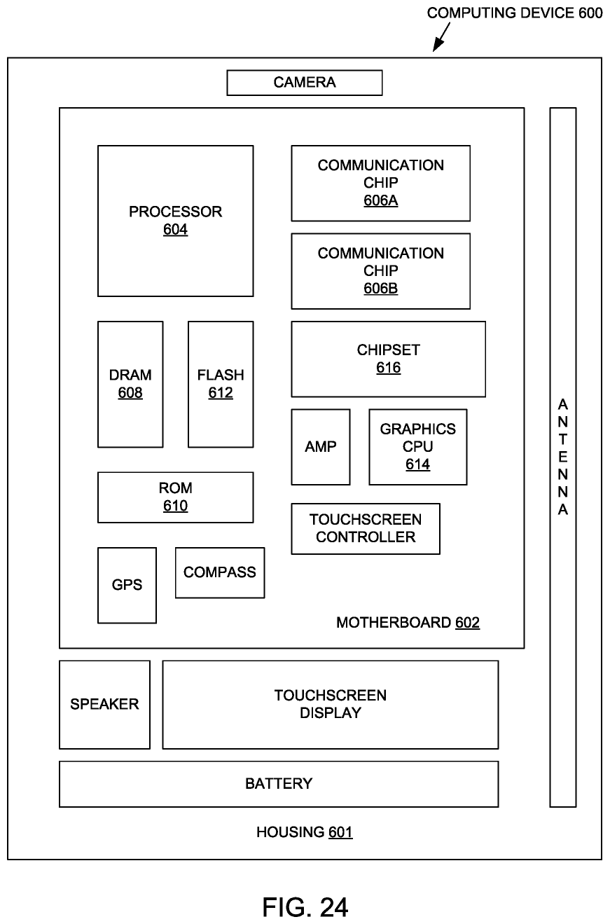

FIG. 24 illustrates an electronic or computing device 600 in accordance with one implementation of the present description. The computing device 600 may include a housing 601 having a board 602 disposed therein. The computing device 600 may include a number of integrated circuit components, including but not limited to a processor 604, at least one communication chip 606A, 606B, volatile memory 608 (e.g., DRAM), non-volatile memory 610 (e.g., ROM), flash memory 612, a graphics processor or CPU 614, a digital signal processor (not shown), a crypto processor (not shown), a chipset 616, an antenna, a display (touchscreen display), a touchscreen controller, a battery, an audio codec (not shown), a video codec (not shown), a power amplifier (AMP), a global positioning system (GPS) device, a compass, an accelerometer (not shown), a gyroscope (not shown), a speaker, a camera, and a mass storage device (not shown) (such as hard disk drive, compact disk (CD), digital versatile disk (DVD), and so forth). Any of the integrated circuit components may be physically and electrically coupled to the board 602. In some implementations, at least one of the integrated circuit components may be a part of the processor 604.

The communication chip enables wireless communications for the transfer of data to and from the computing device. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device may include a plurality of communication chips. For instance, a first communication chip may be dedicated to shorter range wireless communications such as Wi-Fi and Bluetooth and a second communication chip may be dedicated to longer range wireless communications such as GPS, EDGE, GPRS, CDMA, WiMAX, LTE, Ev-DO, and others.

The term “processor” may refer to any device or portion of a device that processes electronic data from registers and/or memory to transform that electronic data into other electronic data that may be stored in registers and/or memory.

At least one of the integrated circuit components may include an integrated circuit package, which comprises a first integrated circuit assembly, wherein the first integrated circuit assembly includes a first surface, an opposing second surface, and at least one side surface extending from the first surface of the first integrated circuit assembly to the second surface of the first integrated circuit assembly, and wherein the first integrated circuit assembly includes at least one waveguide; a second integrated circuit assembly, wherein the second integrated circuit assembly includes a first surface, an opposing second surface, and at least one side surface extending from the first surface of the second integrated circuit assembly to the second surface of the second integrated circuit assembly, and wherein the second integrated circuit assembly includes at least one waveguide; and an optical signal transfer assembly between the at least one side of the first integrated circuit assembly and the at least one side of the second integrated circuit assembly, wherein the optical signal transfer assembly is optically coupled with the at least one waveguide of the first integrated circuit assembly and the at least one waveguide of the second integrated circuit assembly.

In various implementations, the computing device may be a laptop, a netbook, a notebook, an ultrabook, a smartphone, a tablet, a personal digital assistant (PDA), an ultra-mobile PC, a mobile phone, a desktop computer, a server, a printer, a scanner, a monitor, a set-top box, an entertainment control unit, a digital camera, a portable music player, or a digital video recorder. In further implementations, the computing device may be any other electronic device that processes data.

It is understood that the subject matter of the present description is not necessarily limited to specific applications illustrated in FIGS. 1-24. The subject matter may be applied to other integrated circuit devices and assembly applications, as well as any appropriate electronic application, as will be understood to those skilled in the art.

The following examples pertain to further embodiments and specifics in the examples may be used anywhere in one or more embodiments, wherein Example 1 is an apparatus, comprising a first integrated circuit assembly, wherein the first integrated circuit assembly includes a first surface, an opposing second surface, and at least one side surface extending from the first surface of the first integrated circuit assembly to the second surface of the first integrated circuit assembly, and wherein the first integrated circuit assembly includes at least one waveguide; a second integrated circuit assembly, wherein the second integrated circuit assembly includes a first surface, an opposing second surface, and at least one side surface extending from the first surface of the second integrated circuit assembly to the second surface of the second integrated circuit assembly, and wherein the second integrated circuit assembly includes at least one waveguide; and an optical signal transfer assembly extending between the at least one side of the first integrated circuit assembly and the at least one side of the second integrated circuit assembly, wherein the optical signal transfer assembly is optically coupled with the at least one waveguide of the first integrated circuit assembly and the at least one waveguide of the second integrated circuit assembly.

In Example 2, the subject matter of Example 1 can optionally include at least one of first integrated circuit assembly and the second integrated circuit assembly comprises a plurality of integrated circuit devices.

In Example 3, the subject matter of any of Examples 1 and 2 can optionally include the waveguide of the first integrated circuit assembly extends to the at least one side of the first integrated circuit assembly, wherein the waveguide of the second integrated circuit assembly extends to the at least one side of the second integrated circuit assembly, and wherein the optical signal transfer assembly abuts the at least one side of the first integrated circuit assembly and abuts the at least one side of the second integrated circuit assembly.

In Example 4, the subject matter of Example 3 can optionally include the optical transfer assembly comprising a plurality of lens.

In Example 5, the subject matter of Example 4 can optionally include an array structure adjacent the plurality of lens.

In Example 6, the subject matter of any of Examples 4 to 5 can optionally include the plurality of lens comprises a first lens coupled to the at least one waveguide of the first integrated circuit assembly and a second lens coupled to the at least one waveguide of the second integrated circuit assembly.

In Example 7, the subject matter of any of Examples 4 to 6 can optionally include a gap between the first lens and the second lens.

In Example 8, the subject matter of any of Examples 4 to 7 can optionally include the first lens comprising a first micro-lens array coupled to the at least one waveguide of the first integrated circuit assembly and the second lens comprising a second micro-lens array coupled to the at least one waveguide of the second integrated circuit assembly.

In Example 9, the subject matter of Example 1 can optionally include the optical signal transfer assembly comprising an optical bridge.

In Example 10, the subject matter of Example 9 can optionally include the optical bridge comprising a waveguide.

Example 11 is an integrated circuit package, comprising a package substrate; a first integrated circuit assembly electrically attached to the package substrate, wherein the first integrated circuit assembly includes a first surface, an opposing second surface, and at least one side surface extending from the first surface of the first integrated circuit assembly to the second surface of the first integrated circuit assembly, and wherein the first integrated circuit assembly includes at least one waveguide; a second integrated circuit assembly electrically attached to the package substrate, wherein the second integrated circuit assembly includes a first surface, an opposing second surface, and at least one side surface extending from the first surface of the second integrated circuit assembly to the second surface of the second integrated circuit assembly, and wherein the second integrated circuit assembly includes at least one waveguide; and an optical signal transfer assembly extending between the at least one side of the first integrated circuit assembly and the at least one side of the second integrated circuit assembly, wherein the optical signal transfer assembly is optically coupled with the at least one waveguide of the first integrated circuit assembly and the at least one waveguide of the second integrated circuit assembly.

In Example 12, the subject matter of Example 11 can optionally include at least one of first integrated circuit assembly and the second integrated circuit assembly comprises a plurality of integrated circuit devices.

In Example 13, the subject matter of any of Examples 11 and 12 can optionally include the waveguide of the first integrated circuit assembly extends to the at least one side of the first integrated circuit assembly, wherein the waveguide of the second integrated circuit assembly extends to the at least one side of the second integrated circuit assembly, and wherein the optical signal transfer assembly abuts the at least one side of the first integrated circuit assembly and abuts the at least one side of the second integrated circuit assembly.

In Example 14, the subject matter of Example 13 can optionally include the optical transfer assembly comprising a plurality of lens.

In Example 15, the subject matter of Example 14 can optionally include an array structure adjacent the plurality of lens.

In Example 16, the subject matter of any of Examples 14 to 15 can optionally include the plurality of lens comprises a first lens coupled to the at least one waveguide of the first integrated circuit assembly and a second lens coupled to the at least one waveguide of the second integrated circuit assembly.

In Example 17, the subject matter of any of Examples 14 to 16 can optionally include a gap between the first lens and the second lens.

In Example 18, the subject matter of any of Examples 14 to 17 can optionally include the first lens comprising a first micro-lens array coupled to the at least one waveguide of the first integrated circuit assembly and the second lens comprising a second micro-lens array coupled to the at least one waveguide of the second integrated circuit assembly.

In Example 19, the subject matter of Example 11 can optionally include the optical signal transfer assembly comprising an optical bridge.

In Example 20, the subject matter of Example 19 can optionally include the optical bridge comprising a waveguide.

Example 21 is an electronic system, comprising an electronic board and an integrated circuit package electrically attached to the electronic board, wherein the integrated circuit package comprises: a package substrate; a first integrated circuit assembly electrically attached to the package substrate, wherein the first integrated circuit assembly includes a first surface, an opposing second surface, and at least one side surface extending from the first surface of the first integrated circuit assembly to the second surface of the first integrated circuit assembly, and wherein the first integrated circuit assembly includes at least one waveguide; a second integrated circuit assembly electrically attached to the package substrate, wherein the second integrated circuit assembly includes a first surface, an opposing second surface, and at least one side surface extending from the first surface of the second integrated circuit assembly to the second surface of the second integrated circuit assembly, and wherein the second integrated circuit assembly includes at least one waveguide; and an optical signal transfer assembly extending between the at least one side of the first integrated circuit assembly and the at least one side of the second integrated circuit assembly, wherein the optical signal transfer assembly is optically coupled with the at least one waveguide of the first integrated circuit assembly and the at least one waveguide of the second integrated circuit assembly.

In Example 22, the subject matter of Example 21 can optionally include at least one of first integrated circuit assembly and the second integrated circuit assembly comprises a plurality of integrated circuit devices.

In Example 23, the subject matter of any of Examples 21 and 22 can optionally include the waveguide of the first integrated circuit assembly extends to the at least one side of the first integrated circuit assembly, wherein the waveguide of the second integrated circuit assembly extends to the at least one side of the second integrated circuit assembly, and wherein the optical signal transfer assembly abuts the at least one side of the first integrated circuit assembly and abuts the at least one side of the second integrated circuit assembly.

In Example 24, the subject matter of Example 23 can optionally include the optical transfer assembly comprising a plurality of lens.

In Example 25, the subject matter of Example 24 can optionally include an array structure adjacent the plurality of lens.

In Example 26, the subject matter of any of Examples 24 to 25 can optionally include the plurality of lens comprises a first lens coupled to the at least one waveguide of the first integrated circuit assembly and a second lens coupled to the at least one waveguide of the second integrated circuit assembly.

In Example 27, the subject matter of any of Examples 24 to 26 can optionally include a gap between the first lens and the second lens.

In Example 28, the subject matter of any of Examples 24 to 27 can optionally include the first lens comprising a first micro-lens array coupled to the at least one waveguide of the first integrated circuit assembly and the second lens comprising a second micro-lens array coupled to the at least one waveguide of the second integrated circuit assembly.

In Example 29, the subject matter of Example 21 can optionally include the optical signal transfer assembly comprising an optical bridge.

In Example 30, the subject matter of Example 29 can optionally include the optical bridge comprising a waveguide.

Having thus described in detail embodiments of the present invention, it is understood that the invention defined by the appended claims is not to be limited by particular details set forth in the above description, as many apparent variations thereof are possible without departing from the spirit or scope thereof.

What is claimed is:

1. An apparatus, comprising:
a first integrated circuit assembly, wherein the first integrated circuit assembly includes a first surface, an opposing second surface, and at least one side surface extending from the first surface of the first integrated circuit assembly to the second surface of the first integrated circuit assembly, and wherein the first integrated circuit assembly includes at least one waveguide;
a second integrated circuit assembly, wherein the second integrated circuit assembly includes a first surface, an opposing second surface, and at least one side surface extending from the first surface of the second integrated circuit assembly to the second surface of the second integrated circuit assembly, and wherein the second integrated circuit assembly includes at least one waveguide; and
an optical signal transfer assembly extending between the at least one side of the first integrated circuit assembly and the at least one side of the second integrated circuit assembly, wherein the optical signal transfer assembly is optically coupled with the at least one waveguide of the first integrated circuit assembly and the at least one waveguide of the second integrated circuit assembly.

2. The apparatus of claim 1, wherein at least one of the first integrated circuit assembly and the second integrated circuit assembly comprises a plurality of integrated circuit devices.

3. The apparatus of claim 1, wherein the waveguide of the first integrated circuit assembly extends to the at least one side of the first integrated circuit assembly, wherein the waveguide of the second integrated circuit assembly extends to the at least one side of the second integrated circuit assembly, and wherein the optical signal transfer assembly abuts the at least one side of the first integrated circuit assembly and abuts the at least one side of the second integrated circuit assembly.

4. The apparatus of claim 3, wherein the optical transfer assembly comprises a plurality of lens.

5. The apparatus of claim 4 further including an array structure adjacent the plurality of lens.

6. The apparatus of claim 4, wherein the plurality of lens comprises a first lens coupled to the at least one waveguide of the first integrated circuit assembly and a second lens coupled to the at least one waveguide of the second integrated circuit assembly.

7. The apparatus of claim 4, wherein the first lens comprises a first micro-lens array coupled to the at least one waveguide of the first integrated circuit assembly and wherein the second lens comprises a second micro-lens array coupled to the at least one waveguide of the second integrated circuit assembly.

8. The apparatus of claim 1, wherein the optical signal transfer assembly comprises an optical bridge.

9. An integrated circuit package, comprising:
a package substrate;
a first integrated circuit assembly electrically attached to the package substrate, wherein the first integrated circuit assembly includes a first surface, an opposing second surface, and at least one side surface extending from the first surface of the first integrated circuit assembly to the second surface of the first integrated circuit assembly, and wherein the first integrated circuit assembly includes at least one waveguide;
a second integrated circuit assembly electrically attached to the package substrate, wherein the second integrated circuit assembly includes a first surface, an opposing second surface, and at least one side surface extending from the first surface of the second integrated circuit assembly to the second surface of the second integrated circuit assembly, and wherein the second integrated circuit assembly includes at least one waveguide; and
an optical signal transfer assembly extending between the at least one side of the first integrated circuit assembly and the at least one side of the second integrated circuit assembly, wherein the optical signal transfer assembly is optically coupled with the at least one waveguide of the first integrated circuit assembly and the at least one waveguide of the second integrated circuit assembly.

10. The integrated circuit package of claim 9, wherein at least one of the first integrated circuit assembly and the second integrated circuit assembly comprises a plurality of integrated circuit devices.

11. The integrated circuit package of claim 9, wherein the waveguide of the first integrated circuit assembly extends to the at least one side of the first integrated circuit assembly, wherein the waveguide of the second integrated circuit assembly extends to the at least one side of the second integrated circuit assembly, and wherein the optical signal transfer assembly abuts the at least one side of the first integrated circuit assembly and abuts the at least one side of the second integrated circuit assembly.

12. The integrated circuit package of claim 11, wherein the optical transfer assembly comprises a plurality of lens.

13. The integrated circuit package of claim 12 further including an array structure adjacent the plurality of lens.

14. The integrated circuit package of claim 12, wherein the plurality of lens comprises a first lens coupled to the at least one waveguide of the first integrated circuit assembly and a second lens coupled to the at least one waveguide of the second integrated circuit assembly.

15. The integrated circuit package of claim 12, wherein the first lens comprises a first micro-lens array coupled to the at least one waveguide of the first integrated circuit assembly and wherein the second lens comprises a second micro-lens array coupled to the at least one waveguide of the second integrated circuit assembly.

16. The integrated circuit package of claim 9, wherein the optical signal transfer assembly comprises an optical bridge.

17. A system, comprising:
an electronic board; and
an integrated circuit package electrically attached to the electronic board, wherein the integrated circuit package comprises:
a package substrate;
a first integrated circuit assembly electrically attached to the package substrate, wherein the first integrated circuit assembly includes a first surface, an opposing second surface, and at least one side surface extending from the first surface of the first integrated circuit assembly to the second surface of the first integrated circuit assembly, and wherein the first integrated circuit assembly includes at least one waveguide;
a second integrated circuit assembly electrically attached to the package substrate, wherein the second integrated circuit assembly includes a first surface, an opposing second surface, and at least one side surface extending from the first surface of the second integrated circuit assembly to the second surface of the second integrated circuit assembly, and wherein the second integrated circuit assembly includes at least one waveguide; and
an optical signal transfer assembly extending between the at least one side of the first integrated circuit assembly and the at least one side of the second integrated circuit assembly, wherein the optical signal transfer assembly is optically coupled with the at least one waveguide of the first integrated circuit assembly and the at least one waveguide of the second integrated circuit assembly.

18. The system of claim 21, wherein the waveguide of the first integrated circuit assembly extends to the at least one side of the first integrated circuit assembly, wherein the waveguide of the second integrated circuit assembly extends to the at least one side of the second integrated circuit assembly, and wherein the optical signal transfer assembly abuts the at least one side of the first integrated circuit assembly and abuts the at least one side of the second integrated circuit assembly.

19. The system of claim 18, wherein the optical transfer assembly comprises a plurality of lens.

20. The system of claim 17, wherein the optical signal transfer assembly comprises an optical bridge.
